(19) United States
(12) Patent Application Publication
(10) Pub. No.: US 2026/0302314 A1
(43) Pub. Date: Oct. 1, 2026

(54) METHOD OF MANUFACTURING UNIT CELL OF ALL-SOLID RECHARGEABLE BATTERY

(71) Applicant: SAMSUNG SDI CO., LTD., Yongin-si, Gyeonggi-do (KR)

(72) Inventors: Sung-Hyun CHOI, Yongin-si, Gyeonggi-do (KR); Hyungnoh JUNG, Yongin-si, Gyeonggi-do (KR); Sanghoon CHOI, Yongin-si, Gyeonggi-do (KR); Jaeyong KIM, Yongin-si, Gyeonggi-do (KR); Chanjin CHOI, Yongin-si, Gyeonggi-do (KR)

(21) Appl. No.: 18/880,456

(22) PCT Filed: Apr. 4, 2024
(86) PCT No.: PCT/KR2024/095672

§ 371 Date: Dec. 31, 2024

(30) Foreign Application Priority Data
Sep. 14, 2023 (KR) 10-2023-0122758

(51) Int. Cl. H01M 10/04; H01M 10/0585

(52) U.S. Cl. CPC H01M 10/0468; H01M 10/0585

(57) ABSTRACT

A method of manufacturing a unit cell of an all-solid rechargeable battery is provided. A method of manufacturing a unit cell of an all-solid rechargeable battery includes a first step of continuously supplying a negative electrode plate in a reel state, a second step of forming a pre-pressing unit cell by introducing a positive electrode plate having a positive electrode active material layer in a single sheet state onto the negative electrode plate, a third step of compensating for a step set as a height from an inner surface of the negative electrode plate to an outer surface of the positive electrode plate by arranging a step compensation member on the negative electrode plate outside the positive electrode plate in the unit cell, a fourth step of roll-pressing the positive electrode plate and the step compensation member arranged on the negative electrode plate by passing them between a pair of press rolls, and a fifth step of cutting the negative electrode plate and positive electrode plate integrated by the roll pressing into the unit cell.

### TECHNICAL FIELD

The present disclosure relates to a method of manufacturing a unit cell of an all-solid rechargeable battery.

### BACKGROUND ART

Recently, in response to industrial demands, the development of batteries with high energy density and safety has been actively conducted. For example, lithium-ion batteries are being put into practical use not only in the fields of information-related devices and communication devices, but also in the field of automobiles. In the field of automobiles, safety is especially important because life is involved.

Lithium-ion batteries currently on the market use electrolyte solutions containing flammable organic solvents, so there is a possibility of overheating and fire in the event of a short circuit. Accordingly, an all-solid rechargeable battery using a solid electrolyte instead of an electrolyte solution has been proposed.

By not using flammable organic solvents, all-solid secondary batteries can greatly reduce the possibility of fire or explosion even in the event of a short circuit. Therefore, the all-solid batteries can greatly increase safety compared to lithium-ion batteries using electrolyte solutions.

The above-described information disclosed in the technology that serves as the background of the present disclosure is only for improving understanding of the background of the present disclosure, and thus may include information that does not constitute the related art.

### DISCLOSURE

### Technical Problem

An embodiment provides a method of manufacturing a unit cell of an all-solid rechargeable battery, which minimizes damage to an electrode plate due to a difference in thickness when roll pressing a unit cell of an all-solid rechargeable battery.

### Technical Solution

A method of manufacturing a unit cell of an all-solid rechargeable battery according to an embodiment includes a first step of continuously supplying a negative electrode plate in a reel state, a second step of forming a pre-pressing unit cell by introducing a positive electrode plate having a positive electrode active material layer in a single sheet state onto the negative electrode plate, a third step of compensating for a step set as a height from an inner surface of the negative electrode plate to an outer surface of the positive electrode plate by arranging a step compensation member on the negative electrode plate outside the positive electrode plate in the unit cell, a fourth step of roll-pressing the positive electrode plate and the step compensation member arranged on the negative electrode plate by passing them between a pair of press rolls, and a fifth step of cutting the negative electrode plate and positive electrode plate integrated by the roll pressing into the unit cell.

In the second step, the positive electrode plate including a positive electrode active material layer on a positive electrode current collector and a solid electrolyte layer on the positive electrode active material layer may be introduced.

In the first step, the negative electrode plate including a solid electrolyte layer on a negative electrode current collector may be introduced.

In the third step, the step compensation member may be supplied in a continuous structure corresponding to a plurality of the unit cells.

In the second step, the positive electrode plate having a lead tab on one side may be supplied, and in the third step, the step may be compensated for by arranging a unit compensation portion, corresponding to the unit cell, of the step compensation member outside the positive electrode plate.

In the third step, a first gap G1 may be formed between a periphery of the positive electrode plate and an inner surface of the unit compensation portion when viewed in an advancing direction of the unit cell.

In the third step, an upper surface of the positive electrode plate may be made to have a first height difference ΔH1 higher than an upper surface of the unit compensation portion when viewed in a roll pressing direction for the unit cell.

In the third step, the step compensation member having a thickness corresponding to 80 to 90% of a total thickness of the positive electrode plate and the solid electrolyte layer may be supplied.

In the third step, an upper surface of the positive electrode plate may be made to have a second height difference ΔH2 lower than an upper surface of the unit compensation portion when viewed in a roll pressing direction for the unit cell.

In the third step, the step compensation member having a thickness corresponding to 80 to 110% of a total thickness of a current collector and a positive electrode active material layer of the positive electrode plate.

In the third step, the step compensation member may be formed in a quadrilateral frame structure corresponding to a periphery of the unit cell formed in a rectangular shape and supplied.

In the third step, an adhesive tape or a paper tape may be supplied as the step compensation member.

The fourth step may further include a step of continuously removing the step compensation member that has been pressed.

### Advantageous Effects

In an embodiment, a negative electrode plate is continuously supplied in a reel state, a positive electrode plate having a positive electrode active material layer is introduced in a single sheet state onto the negative electrode plate, and a step compensation member is arranged on the negative electrode plate positioned outside the positive electrode plate in a pre-pressing unit cell to compensate for a step set as a height from an inner surface of the negative electrode plate to an outer surface of the positive electrode plate, allowing for minimization of damage to the plates due to a thickness difference during roll pressing for a unit cell of a rechargeable battery.

### DESCRIPTION OF THE DRAWINGS

FIG. 1 is a cross-sectional view showing an all-solid rechargeable battery according to an embodiment of the present invention.

FIG. 2 is a longitudinal cross-sectional view showing formation of a lithium metal layer in the all-solid rechargeable battery according to the embodiment.

FIG. 3 is a flow chart of a method of manufacturing a unit cell of an all-solid rechargeable battery according to a first embodiment of the present invention.

FIG. 4 is a side view showing the method of manufacturing a unit cell of an all-solid rechargeable battery according to the first embodiment of the present invention.

FIG. 5 is a plan view of FIG. 4.

FIG. 6 is a cross-sectional view showing a height relationship between the unit cell of FIG. 4 and a step compensation member.

FIG. 7 is a cross-sectional view showing a height relationship between a unit cell and a step compensation member in a method of manufacturing a unit cell of an all-solid rechargeable battery according to a second embodiment of the present invention.

FIG. 8 is a side view showing a method of manufacturing a unit cell of an all-solid rechargeable battery according to a third embodiment of the present invention.

FIG. 9 is a plan view of FIG. 8.

### MODE FOR INVENTION

In the following detailed description, only certain embodiments of the present invention have been shown and described, simply by way of illustration. As those skilled in the art would realize, the described embodiments may be modified in various different ways, all without departing from the spirit or scope of the present invention.

In addition, unless explicitly described to the contrary, the word “comprise”, and variations such as “comprises” or “comprising”, will be understood to imply the inclusion of stated elements but not the exclusion of any other elements.

In the drawings, the thickness of layers, films, panels, regions, etc., are exaggerated for clarity, and like reference numerals designate like elements throughout the specification. It will be understood that when an element such as a layer, film, region, or substrate is referred to as being “on” another element, it can be directly on the other element or intervening elements may also be present. In contrast, when an element is referred to as being “directly on” another element, there are no intervening elements present.

In addition, “layer” herein includes not only a shape formed on the whole surface when viewed from a plan view, but also a shape formed on a partial surface. Here, “or” is not to be construed as an exclusive meaning, and for example, “A or B” is construed to include A, B, A+B, and the like.

### Positive Electrode for All-Solid Rechargeable Battery

An embodiment provides a positive electrode for an all-solid rechargeable battery including a current collector and a positive electrode active material layer positioned on the current collector, wherein the positive electrode active material layer includes at least one of a positive electrode active material, a sulfide-based solid electrolyte, a binder, and a conductive material. However, without being limited thereto, the positive electrode for an all-solid rechargeable battery may include more or fewer components than the components described above.

In an embodiment, the positive electrode for an all-solid rechargeable battery is manufactured by applying a positive electrode composition including at least one of a positive electrode active material, a sulfide-based solid electrolyte, a binder, and a conductive material to a current collector, followed by drying and rolling.

### Positive Electrode Active Material

The positive electrode active material can be applied without limitation as long as it is commonly used for all-solid secondary batteries. For example, the positive electrode active material may be a compound capable of reversible intercalation and deintercalation of lithium and may include a compound represented by any one of the following chemical formulas.

$$L {i}_{a} {A}_{1 - b} {X}_{b} {D}_{2} ( 0.90 \leq a \leq 1.8 , 0 \leq b \leq 0 \text{.5} ) ;$$

$$L {i}_{a} {A}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$$L {i}_{a} {E}_{1 - b} {X}_{b} {O}_{2 - c} {D}_{c} ( 0.90 \leq a \leq 1.8 , 0 \leq b \leq 0.5 , 0 \leq c \leq 0.05 ) ;$$

$$L {i}_{a} {E}_{2 - b} {X}_{b} {O}_{4 - c} {D}_{c} ( 0.90 \leq a \leq 1.8 , 0 \leq b \leq 0.5 , 0 \leq c \leq 0.05 ) ;$$

$$L {i}_{a} N {i}_{1 - b - c} C {o}_{b} {X}_{c} {D}_{α} ( 0.90 \leq a \leq 1.8 , 0 \leq b \leq 0.5 , 0 \leq c \leq 0.5 , 0 < α \leq 2 ) ;$$

$$L {i}_{a} N {i}_{1 - b - c} C {o}_{b} {X}_{c} {O}_{2 - α} {T}_{0} ( 0.90 \leq a \leq 1.8 , 0 \leq b \leq 0.5 , 0 \leq c \leq 0.05 , 0 < α < 2 ) ;$$

$$L {i}_{a} N {i}_{1 - b - c} C {o}_{b} {X}_{c} {O}_{2 - α} {T}_{2} ( 0.90 \leq a \leq 1.8 , 0 \leq b \leq 0.5 , 0 \leq c \leq 0.05 , 0 < α < 2 ) ;$$

$$L {i}_{a} N {i}_{1 - b - c} M {n}_{b} {X}_{c} {D}_{α} ( 0.9 \leq a \leq 1.8 , 0 \leq b \leq 0.5 , 0 \leq c \leq 0.05 , 0 < α \leq 2 ) ;$$

$$L {i}_{a} N {i}_{1 - b - c} M {n}_{b} {X}_{c} {O}_{2 - α} {T}_{0} ( 0.90 \leq a \leq 1.8 , 0 \leq b \leq 0.5 , 0 \leq c \leq 0.05 , 0 < α < 2 ) ;$$

$$L {i}_{a} N {i}_{1 - b - c} M {n}_{b} {X}_{c} {O}_{2 - α} {T}_{2} ( 0.90 \leq a \leq 1.8 , 0 \leq b \leq 0.5 , 0 \leq c \leq 0.05 , 0 < α < 2 ) ;$$

$$L {i}_{a} N {i}_{b} {E}_{c} {G}_{d} {O}_{2} ( 0.90 \leq a \leq 1.8 , 0 \leq b \leq 0.9 , 0 \leq c \leq 0.5 , 0.001 \leq d \leq 0 \text{.1} ) ;$$

$$L {i}_{a} N {i}_{b} C {o}_{c} M {n}_{d} {G}_{e} {O}_{2} ( 0.90 \leq a \leq 1.8 , 0 \leq b \leq 0 \text{.9} , 0 \leq c \leq 0.5 , 0 \leq d \leq 0 \text{.5} , \leq e \leq 0.1 ) ;$$

$$L {i}_{a} N i {G}_{b} {O}_{2} ( 0.90 \leq a \leq 1.8 , 0.001 \leq b \leq 0 \text{.1} ) ;$$

$$L {i}_{a} C o {G}_{b} {O}_{2} ( 0.90 \leq a \leq 1.8 , 0.001 \leq b \leq 0 \text{.1} ) ;$$

$$L {i}_{a} M {n}_{1 - b} {G}_{b} {O}_{2} ( 0.90 \leq a \leq 1.8 , 0.001 \leq b \leq 0 \text{.1} ) ;$$

$$L {i}_{a} M {n}_{2} {G}_{b} {O}_{4} ( 0.90 \leq a \leq 1.8 , 0.001 \leq b \leq 0 \text{.1} ) ;$$

$$L {i}_{a} M {n}_{1 - g} {G}_{g} P {O}_{4} ( 0.90 \leq a \leq 1.8 , 0 \leq g \leq 0 \text{.5} ) ;$$

$$Q {O}_{2} ; Q {S}_{2} ; L i Q {S}_{2} ;$$

$${V}_{2} {O}_{5} ; L i {V}_{2} {O}_{5} ;$$

$$L i Z {O}_{2} ;$$

$$L i N i V {O}_{4} ;$$

$$L {i}_{( 3 - f )} {J}_{2} P {O}_{43} ( 0 \leq f \leq 2 ) ;$$

$$L {i}_{( 3 - f )} F {e}_{2} P {O}_{43} ( 0 \leq f \leq 2 ) ;$$

$$L {i}_{a} F e P {O}_{4} ( 0.90 \leq a \leq 1.8 ) .$$

In the above Chemical Formulas, A is selected from the group consisting of Ni, Co, Mn, and a combination thereof; X is selected from the group consisting of Al, Ni, Co, Mn, Cr, Fe, Mg, Sr, V, rare earth elements, and a combination thereof; D is selected from the group consisting of O, F, S, P, and a combination thereof; E is selected from the group consisting of Co, Mn, and a combination thereof; T is selected from the group consisting of F, S, P, and a combination thereof; G is selected from the group consisting of Al, Cr, Mn, Fe, Mg, La, Ce, Sr, V, and a combination thereof; Q is selected from the group consisting of Ti, Mo, Mn, and a combination thereof; Z is selected from the group consisting of Cr, V, Fe, Sc, Y, and a combination thereof; and J is selected from the group consisting of V, Cr, Mn, Co, Ni, Cu, and a combination thereof.

The positive electrode active material may be, for example, lithium cobalt oxide (LCO), lithium nickel oxide (LNO), lithium nickel cobalt oxide (NC), lithium nickel cobalt aluminum oxide (NCA), lithium nickel cobalt manganese oxide (NCM), and lithium nickel manganese oxide (NM), lithium manganese oxide (LMO), or lithium ferrous phosphate oxide (LFP).

The positive electrode active material may include a lithium nickel-based oxide represented by Chemical Formula 1 below, a lithium cobalt-based oxide represented by Chemical Formula 2 below, a lithium ferrous phosphate-based compound represented by Chemical Formula 3 below, or a combination thereof.

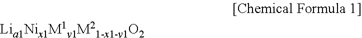

In Chemical Formula 1, 0.9≤a1≤1.8, 0.3≤x1≤1, 0≤y1≤0.7, and M¹ and M² are each one or more elements independently selected from the group consisting of Al, B, Ba, Ca, Ce, Co, Cr, Cu, F, Fe, Mg, Mn, Mo, Nb, P, S, Si, Sr, Ti, V, W, and Zr.

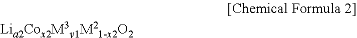

In Chemical Formula 2, 0.9≤a2≤1.8, 0.6≤x2≤1, and M³ is one or more elements selected from the group consisting of Al, B, Ba, Ca, Ce, Cr, Cu, F, Fe, Mg, Mn, Mo, Nb, P, S, Si, Sr, Ti, V, W, and Zr.

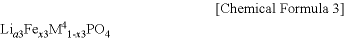

In Chemical Formula 3, 0.9≤a3≤1.8, 0.6≤x3≤1, and M⁴ is one or more elements selected from the group consisting of Al, B, Ba, Ca, Ce, Co, Cr, Cu, F, Fe, Mg, Mn, Mo, Nb, P, S, Si, Sr, Ti, V, W, and Zr.

An average particle diameter (D50) of the positive electrode active material may be 1 μm to 25 μm, for example, 3 μm to 25 μm, 5 μm to 25 μm, 5 μm to 20 μm, 8 μm to 20 μm, or 10 μm to 18 μm. The positive electrode active material having the particle diameter range can be harmoniously mixed with other components in the positive electrode active material layer and can implement the high capacity and high energy density.

The positive electrode active material may be in the form of a secondary particle made by agglomeration of a plurality of primary particles, or may be in the form of a single particle. In addition, the positive electrode active material may be spherical or close to a spherical shape, or may be polyhedral or amorphous.

### Sulfide-Based Solid Electrolyte

The sulfide-based solid electrolyte may include, for example, Li₂S—P₂S₅, Li₂S—P₂S₅—LiX (X is a halogen element, for example I, or Cl), Li₂S—P₂S₅—Li₂O, Li_{z}S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (m and n are each an integer, and Z is Ge, Zn, or Ga), Li_{z}S—GeS₂, Li_{z}S—SiS₂—Li₃PO₄, Li_{z}S—SiS₂-LiₚMO_{q} (p and q are integers, and M is P, Si, Ge, B, Al, Ga, or In), or combination thereof.

The sulfide-based solid electrolyte may be obtained by, for example, mixing Li₂S and P₂S₅ at a molar ratio of 50:50 to 90:10 or 50:50 to 80:20 and optionally heat treating the mixture. Within the above mixing ratio range, a sulfide-based solid electrolyte with excellent ionic conductivity can be manufactured. Here, SiS₂, GeS₂, B₂S₃, and the like as other components may be further included to further improve the ionic conductivity.

A mechanical milling or solution method can be applied as a method of mixing sulfur-containing raw materials for producing a sulfide-based solid electrolyte. The mechanical milling is a method of making starting materials into particulates and mixing the same by putting the starting materials, ball mills, and the like in a reactor and intensely stirring them. In the solution method, starting materials may be mixed in a solvent to obtain a solid electrolyte as a precipitate. Furthermore, if heat treatment is performed after mixing, crystals of the solid electrolyte can become more rigid and ionic conductivity can be improved. As an example, the sulfide-based solid electrolyte can be manufactured by mixing sulfur-containing raw materials and heat-treating them two or more times. In this case, a sulfide-based solid electrolyte with high ionic conductivity and rigidity can be manufactured.

As an example, the sulfide-based solid electrolyte particles may include argyrodite-type sulfide. The argyrodite-type sulfide can be represented by, for example, Chemical Formula of LiₐM_{b}P_{c}S_{d}Aₑ (a, b, c, d, and e are all 0 or greater and 12 or less, M is metal excluding Li or a combination of a plurality of metals excluding Li, and A is F, Cl, Br, or I), and specifically, can be represented by Chemical Formula of Li₇₋ₓPS₆₋ₓAₓ (x is 0.2 or greater and 1.8 or less, and A is F, Cl, Br, or I). The argyrodite-type sulfide may be specifically Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, or the like.

A sulfide-based solid electrolyte particle containing such argyrodite-type sulfide has high ionic conductivity close to about 10⁻⁴ to about 10⁻² S/cm, which is ionic conductivity of a general liquid electrolyte, at room temperature, and thus, can form a close bond between the positive electrode active material and the solid electrolyte, and further, a close interface between the electrode layer and the solid electrolyte layer without deteriorating the ionic conductivity. An all-solid battery including the same may exhibit improved battery performance such as rate characteristics, coulombic efficiency, and life characteristics.

The argyrodite-type sulfide-based solid electrolyte may be manufactured by, for example, mixing lithium sulfide, phosphorus sulfide, and optionally lithium halide. After mixing them, heat treatment may be performed. The heat treatment may include, for example, two or more heat treatment steps.

An average particle diameter (D50) of the sulfide-based solid electrolyte particle according to an embodiment may be 5.0 μm or less, for example, 0.1 μm to 5.0 μm, 0.1 μm to 4.0 μm, 0.1 μm to 3.0 μm, 0.5 μm to 2.0 μm, or 0.1 μm to 1.5 μm. Alternatively, the sulfide-based solid electrolyte particle may be a small particle having an average particle diameter (D50) of 0.1 μm to 1.0 μm or a large particle having an average particle diameter (D50) of 1.5 μm to 5.0 μm, depending on the location or purpose of use. The sulfide-based solid electrolyte particle in the particle diameter range can effectively penetrate between solid particles in the battery, and has an excellent contact property with the electrode active material and connectivity between the solid electrolyte particles. The average particle diameter of the sulfide-based solid electrolyte particle may be measured using a microscope image. For example, a particle size distribution may be obtained by measuring sizes of about 20 particles in a scanning electron microscope image, and D50 may be calculated from the particle size distribution.

The content of the solid electrolyte in the positive electrode for an all-solid battery may be 0.5 wt % to 35 wt %, for example, 1 wt % to 35 wt %, 5 wt % to 30 wt %, 8 wt % to 25 wt %, or 10 wt % to 20 wt %. This is a content with respect to a total weight of components in the positive electrode, and specifically, may be a content with respect to a total weight of the positive electrode active material layer.

In an embodiment, the positive electrode active material layer may include 50 wt % to 99.35 wt % of the positive electrode active material, 0.5 wt % to 35 wt % of the sulfide-based solid electrolyte, 0.1 wt % to 10 wt % of the fluorine-based resin binder, and 0.05 wt % to 5 wt % of the vanadium oxide with respect to 100 wt % of the positive electrode active material layer. When such a content range is satisfied, the positive electrode for an all-solid rechargeable battery maintains high adhesive force and also maintains the viscosity of the positive electrode composition at an appropriate level while implementing high capacity and high ionic conductivity, thereby improving processability.

### Binder

The binder serves to properly adhere positive electrode active material particles to each other and to a current collector. Representative examples may include, but are not limited to, polyvinyl alcohol, carboxylmethyl cellulose, hydroxypropyl cellulose, diacetyl cellulose, polyvinylchloride, carboxylated polyvinylchloride, polyvinylfluoride, an ethylene oxide-containing polymer, polyvinylpyrrolidone, polyurethane, polytetrafluoroethylene, polyvinylidene fluoride, polyethylene, polypropylene, a styrene-butadiene rubber, an acrylated styrene-butadiene rubber, an epoxy resin, nylon, and the like.

### Conductive Material

The positive electrode active material layer may further include a conductive material. The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber containing copper, nickel, aluminum, silver, and the like; a conductive polymer such as a polyphenylene derivative; or a combination thereof.

The conductive material may be included in an amount of 0.1 wt % to 5 wt %, or 0.1 wt % to 3 wt % with respect to a total weight of each component of the positive electrode for the all-solid battery, or with respect to a total weight of the positive electrode active material layer. Within the above content range, the conductive material can improve electrical conductivity without deteriorating battery performance.

When the positive electrode active material layer further includes a conductive material, the positive electrode active material layer may include 45 wt % to 99.25 wt % of the positive electrode active material, 0.5 wt % to 35 wt % of the sulfide-based solid electrolyte, 0.1 wt % to 10 wt % of the fluorine-based resin binder, 0.05 wt % to 5 wt % of the vanadium oxide, and 0.1 wt % to 5 wt % of the conductive material with respect to 100 wt % of the positive electrode active material layer.

Note that the positive electrode for a lithium rechargeable battery may further include an oxide-based inorganic solid electrolyte, in addition to the solid electrolyte described above. The oxide-based inorganic solid electrolyte may include, for example, Li₁₊ₓTi₂₋ₓAl(PO₄)₃ (LTAP) (0≤x≤4), Li_{1+x+y}AlₓTi₂₋ₓSi_{y}P_{3-y}O₁₂ (0<x<2, 0≤y<3), BaTiO₃, Pb(Zr,Ti)O₃ (PZT), Pb₁₋ₓLaₓZr_{1-y}Ti_{y}O₃ (PLZT) (0≤x<1, 0≤y<1), PB(Mg₃Nb_{2/3})O₃—PbTiO₃ (PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0≤x≤2, 0≤y≤3), Li_{1+x+y} (Al, Ga)ₓ (Ti, Ge)₂₋ₓSi_{y}P_{3-y}O₁₂ (0≤x≤1, 0≤y≤1), lithium lanthanum titanate (LixLayTiO3, 0<x<2, 0<y<3), Li₂O, LiAlO₂, Li₂O—Al₂O₃—SiO₂—P₂O₅—TiO₂—GeO₂-based ceramics, Garnet-based ceramics Li₃₊ₓLa₃M₂O₁₂ (M=Te, Nb, or Zr; x is an integer from 1 to 10), or combination thereof.

### All-Solid Rechargeable Battery

An embodiment provides an all-solid rechargeable battery including the positive electrode described above, a negative electrode, and a solid electrolyte layer positioned between the positive electrode and the negative electrode. The all-solid rechargeable battery may also be expressed as an all-solid battery or an all-solid lithium rechargeable battery.

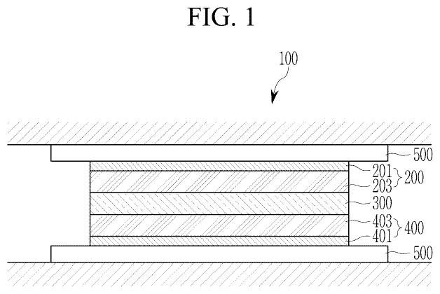

FIG. 1 is a cross-sectional view of an all-solid rechargeable battery according to an embodiment. Referring to FIG. 1, an all-solid rechargeable battery 100 may have such a structure that an electrode assembly in which a negative electrode 400 including a negative electrode current collector 401 and a negative electrode active material layer 403, a solid electrolyte layer 300, and a positive electrode 200 including a positive electrode active material layer 203 and a positive electrode current collector 201 are stacked is stored in a case such as a pouch. The all-solid rechargeable battery 100 may further include an elastic layer 500 on an outer side of at least one of the positive electrode 200 and the negative electrode 400. Although FIG. 1 shows one electrode assembly including the negative electrode 400, the solid electrolyte layer 300, and the positive electrode 200, an all-solid battery may be manufactured by stacking two or more electrode assemblies.

### Negative Electrode

The negative electrode for an all-solid battery may include, for example, a current collector and a negative electrode active material layer positioned on the current collector. The negative electrode active material layer includes a negative electrode active material and may further include a binder, a conductive material, and/or a solid electrolyte.

The negative electrode active material may include a material capable of reversibly intercalation/deintercalating lithium ions, lithium metal, an alloy of lithium metal, a material capable of being doped and undoped with respect to lithium, or a transition metal oxide.

The material capable of reversibly intercalating/deintercalating lithium ions is a carbon-based negative electrode active material, and may include, for example, crystalline carbon, amorphous carbon, or a combination thereof. Examples of the crystalline carbon may include graphite such as amorphous, plate-like, flake-like, spherical or fibrous natural graphite or artificial graphite, and examples of the amorphous carbon may include soft carbon or hard carbon, mesophase pitch carbide, fired coke, and the like.

For the alloy of the lithium metal, an alloy of lithium and one or more metal selected from Na, K, Rb, Cs, Fr, Be, Mg, Ca, Sr, Si, Sb, Pb, In, Zn, Ba, Ra, Ge, Al and Sn may be used.

For the material capable of being doped or undoped with respect to the lithium, a Si-based negative electrode active material or an Sn-based negative electrode active material may be used. Examples of the Si-based negative electrode active material may include silicon, silicon-carbon composite, SiOₓ (0<x<2), and a Si-Q alloy (Q is an element selected from the group consisting of alkali metals, alkali earth metals, Group 13 elements, Group 14 elements, Group 15 elements, Group 16 elements, transition metals, rare-earth elements, and combinations thereof, but is not Si). Examples of the Sn-based negative electrode active material may include Sn, SnO₂, a Sn—R alloy (R is an element selected from the group consisting of alkali metals, alkali earth metals, Group 13 elements, Group 14 elements, Group 15 elements, Group 16 elements, transition metals, rare-earth elements, and combinations thereof, but is not Sn). In addition, a mixture of at least one thereof and SiO₂ may be used. The elements Q and R may be selected and used from the group consisting of Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, and a combination thereof.

The silicon-carbon composite may be, for example, a silicon-carbon composite including a core including crystalline carbon and a silicon particle and an amorphous carbon coating layer positioned on a surface of the core. The crystalline carbon may be artificial graphite, natural graphite, or a combination thereof. As the amorphous carbon precursor, coal-based pitch, mesophase pitch, petroleum-based pitch, coal-based oil, petroleum-based heavy oil, or polymer resin such as phenol resin, furan resin, and polyimide resin may be used. In this case, a content of silicon may be 10 wt % to 50 wt % with respect to a total weight of the silicon-carbon composite. In addition, a content of the crystalline carbon may be 10 wt % to 70 wt % with respect to the total weight of the silicon-carbon composite, and a content of the amorphous carbon may be 20 wt % to 40 wt % with respect to the total weight of the silicon-carbon composite. In addition, a thickness of the amorphous carbon coating layer may be 5 nm to 100 nm.

An average particle diameter (D50) of the silicon particle may be 10 nm to 20 μm, and for example, 10 nm to 500 nm. The silicon particle may be present in an oxidized form, and in this case, an atomic content ratio of Si:O in the silicon particle, which indicates a degree of oxidation, may be 99:1 to 33:67. The silicon particle may be a SiOₓ particle, in which case a range of x in SiOₓ may be greater than 0 and less than 2. Here, the average particle diameter (D50) is measured with a particle size analyzer using a laser diffraction method and refers to a diameter of a particle with a cumulative volume of 50% by volume in the particle size distribution.

The Si-based negative electrode active material or Sₙ-based negative electrode active material may be used by mixing with a carbon-based negative electrode active material. A mixing ratio of the Si-based negative electrode active material or Sₙ-based negative electrode active material and the carbon-based negative electrode active material may be 1:99 to 90:10 at a weight ratio.

A content of the negative electrode active material in the negative electrode active material layer may be 95 wt % to 99 wt % with respect to the total weight of the negative electrode active material layer.

In an embodiment, the negative electrode active material layer further includes a binder, and optionally, may further include a conductive material. A content of the binder in the negative electrode active material layer may be 1 wt % to 5 wt % with respect to the total weight of the negative electrode active material layer. In addition, when a conductive material is further included, the negative electrode active material layer may include 90 wt % to 98 wt % of the negative electrode active material, 1 wt % to 5 wt % of the binder, and 1 wt % to 5 wt % of the conductive material.

The binder serves to adhere the negative electrode active material particles to each other well and also to adhere the negative electrode active material to the current collector well. The binder may include a water-insoluble binder, a water-soluble binder, or a combination thereof.

Examples of the water-insoluble binder may include polyvinyl chloride, carboxylated polyvinyl chloride, polyvinyl fluoride, an ethylene oxide-containing polymer, an ethylene propylene copolymer, polystyrene, polyvinylpyrrolidone, polyurethane, polytetrafluoro ethylene, polyvinylidene fluoride, polyethylene, polypropylene, polyamideimide, polyimide, or a combination thereof.

Examples of the water-soluble binder may include a rubber-based binder or a polymer resin binder. The rubber-based binder may be selected from a styrene-butadiene rubber, an acrylated styrene-butadiene rubber, an acrylonitrile-butadiene rubber, an acrylic rubber, a butyl rubber, a fluoro rubber, and a combination thereof. The polymer resin binder may be selected from polyethylene oxide, polyvinylpyrrolidone, polyepichlorohydrin, polyphosphazene, polyacrylonitrile, an ethylene propylene diene copolymer, polyvinylpyridine, chlorosulfonated polyethylene, latex, a polyester resin, an acrylic resin, a phenol resin, an epoxy resin, polyvinyl alcohol, and a combination thereof.

When a water-soluble binder is used as the negative electrode binder, a thickener capable of imparting viscosity may be used together, and the thickener may include, for example, a cellulose-based compound. The cellulose-based compound may include carboxymethyl cellulose, hydroxypropylmethyl cellulose, methyl cellulose, alkali metal salts thereof, or a combination thereof. As the alkali metal, Na, K, or Li may be used. An amount of the thickener used may be 0.1 to 3 parts by weight with respect to 100 parts by weight of the negative electrode active material.

The conductive material is used to provide conductivity to an electrode, and may include, for example, a carbon-based material such as natural graphite, artificial graphite, carbon black, acetylene black, Ketjen black, a carbon fiber, and a carbon nanotube; a metal-based material in the form of metal powder or metal fiber including copper, nickel, aluminum, silver, and the like; a conductive polymer such as a polyphenylene derivative; or a mixture thereof.

The negative electrode current collector may be selected and used from a copper foil, a nickel foil, a stainless steel foil, a titanium foil, a nickel foam, a copper foam, a polymer substrate coated with a conductive metal, and a combination thereof.

As another example, the negative electrode for an all-solid battery may be a precipitation-type negative electrode. The precipitation-type negative electrode refers to a negative electrode in which a negative electrode active material is not included during assembling of a battery but lithium metal or the like is precipitated during charging of the battery and serves as a negative electrode active material.

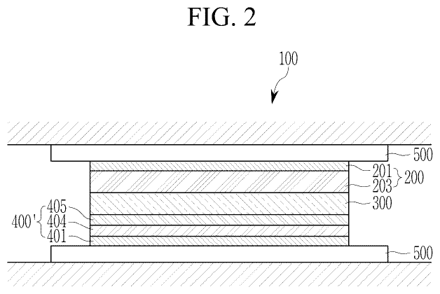

FIG. 2 is a schematic cross-sectional view of an all-solid rechargeable battery including a precipitation-type negative electrode according to an embodiment. Referring to FIG. 2, the precipitation-type negative electrode 400′ may include a current collector 401 and a negative electrode coating layer 405 positioned on the current collector. In an all-solid battery having the precipitation-type negative electrode 400′, initial charging begins in the absence of a negative electrode active material, and during the charging, lithium metal with a high density or the like is precipitated between the current collector 401 and the negative electrode coating layer 405 and forms a lithium metal layer 404, which can serve as a negative electrode active material. Accordingly, in an all-solid battery that has been charged once or more, the precipitation-type negative electrode 400′ may include the current collector 401, the lithium metal layer 404 positioned on the current collector, and the negative electrode coating layer 405 positioned on the metal layer. The lithium metal layer 404 refers to a layer of lithium metal or the like precipitated during the charging process of the battery and may be called a metal layer or a negative electrode active material layer.

The negative electrode coating layer 405 may include metal, a carbon material, or a combination thereof that serves as a catalyst.

The metal may include, for example, gold, platinum, palladium, silicon, silver, aluminum, bismuth, tin, zinc, or a combination thereof, and may be composed of one selected therefrom or an alloy of more than one thereof. When the metal is present in the form of a particle, an average particle diameter (D50) thereof may be about 4 μm or less, for example, 10 nm to 4 μm.

The carbon material may be, for example, crystalline carbon, amorphous carbon, or a combination thereof. The crystalline carbon may be, for example, natural graphite, artificial graphite, a mesophase carbon microbead, or a combination thereof. The amorphous carbon may be, for example, carbon black, activated carbon, acetylene black, Denka black, Ketjen black, or a combination thereof.

When the negative electrode coating layer 405 includes both the metal and the carbon material, a mixing ratio of the metal and the carbon material may be, for example, 1:10 to 2:1 at a weight ratio. In this case, the precipitation of lithium metal can be effectively promoted and the characteristics of the all-solid battery can be improved. The negative electrode coating layer 405 may include, for example, a carbon material on which catalyst metal is supported, or a mixture of metal particles and carbon material particles.

The negative electrode coating layer 405 may include, for example, the metal and amorphous carbon, and in this case, the precipitation of lithium metal can be effectively promoted.

The negative electrode coating layer 405 may further include a binder, and the binder may be a conductive binder. Furthermore, the negative electrode coating layer 405 may further include general additives such as a filler, a dispersant, and an ion conductive material.

A thickness of the negative electrode coating layer 405 may be, for example, 100 nm to 20 μm, 500 nm to 10 μm, or 1 μm to 5 μm.

For example, the precipitation-type negative electrode 400′ may further include a thin film on the surface of the current collector, that is, between the current collector and the negative electrode coating layer. The thin film may contain an element that can form an alloy with lithium. The element that can form an alloy with lithium may be, for example, gold, silver, zinc, tin, indium, silicon, aluminum, bismuth, and the like, and may be composed of one selected therefrom or an alloy of more than one thereof. The thin film can further planarize a precipitation shape of the lithium metal layer 404 and further improve the characteristics of the all-solid battery. The thin film may be formed by, for example, a vacuum deposition method, a sputtering method, a plating method, or the like. The thin film may have a thickness ranging from 1 nm to 500 nm, for example.

### Solid Electrolyte Layer

The solid electrolyte layer 300 may include a sulfide-based solid electrolyte, an oxide-based solid electrolyte, and the like. The specific descriptions of the sulfide-based solid electrolyte and the oxide-based solid electrolyte are the same as above.

In one example, the solid electrolyte included in the positive electrode 200 and the solid electrolyte included in the solid electrolyte layer 300 may include the same compound or different compounds. For example, when both the positive electrode 200 and the solid electrolyte layer 300 include an argyrodite-type sulfide-based solid electrolyte, the overall performance of the all-solid rechargeable battery may be improved. Furthermore, as an example, when both the positive electrode 200 and the solid electrolyte layer 300 include the coated solid electrolyte described above, the all-solid rechargeable battery can implement excellent initial efficiency and life characteristics while implementing a high capacity and a high energy density.

Note that an average particle diameter (D50) of the solid electrolyte layer included in the positive electrode 200 may be smaller than an average particle diameter (D50) of the solid electrolyte included in the solid electrolyte layer 300. In this case, the overall performance can be improved by maximizing the energy density of the all-solid battery and increasing the mobility of lithium ions. For example, the average particle diameter (D50) of the solid electrolyte included in the positive electrode 200 may be 0.1 μm to 1.0 μm, or 0.1 μm to 0.8 μm, and the average particle diameter (D50) of the solid electrolyte included in the solid electrolyte layer 300 may be 1.5 μm to 5.0 μm, 2.0 μm to 4.0 μm, or 2.5 μm to 3.5 μm. When the above particle diameter ranges are satisfied, the energy density of the all-solid rechargeable battery is maximized and the transfer of lithium ions is facilitated, making it possible to suppress resistance and thus to improve the overall performance of the all-solid rechargeable battery. Here, the average particle diameter (D50) of the solid electrolyte may be measured with a particle size analyzer using a laser diffraction method. Alternatively, a particle size distribution may be obtained by measuring sizes of about 20 particles randomly selected from a microscope image such as a scanning electron microscope, and a D50 value may be calculated from the particle size distribution.

The solid electrolyte layer may further include a binder, in addition to the solid electrolyte. In this case, for the binder, a styrene butadiene rubber, polytetrafluoroethylene, polyvinylidene fluoride, polyethylene, an acrylate-based polymer, or a combination thereof may be used, but the present invention is not limited thereto, and any binder used in the art can be used. The acrylate-based polymer may be, for example, butyl acrylate, polyacrylate, polymethacrylate, or a combination thereof.

The solid electrolyte layer may be formed by adding a solid electrolyte to a binder solution, coating a base film with the solution, and drying the resultant. A solvent for the binder solution may be isobutyryl isobutyrate, xylene, toluene, benzene, hexane, or a combination thereof. A process of forming the solid electrolyte layer is widely known in the art, and therefore, a detailed description will be omitted.

A thickness of the solid electrolyte layer may be, for example, 10 μm to 150 μm.

The solid electrolyte layer may further include an alkali metal salt, and/or an ionic liquid, and/or a conductive polymer.

The alkali metal salt may be, for example, a lithium salt. A content of the lithium salt in the solid electrolyte layer may be 1 M or more, for example, 1 M to 4 M. In this case, the lithium salt can improve ionic conductivity by improving lithium ion mobility in the solid electrolyte layer.

The lithium salt may include, for example, LiSCN, LiN(CN)₂, Li(CF₃SO₂)₃C, LiC₄F₉SO₃, LiN(SO₂CF₂CF₃)₂, LiCl, LIF, LiBr, LiI, LiB(C₂O₄)₂, LiBF₄, LiBF₃ (C₂F₅), lithium bis(oxalato) borate (LiBOB), lithium oxalyldifluoroborate (LIODFB), lithium difluoro (oxalato) borate (LiDFOB), lithium bis(trifluoro methanesulfonyl)imide (LiTFSI, LiN(SO₂CF₃)₂), lithium bis(fluorosulfonyl)imide (LiFSI, LiN(SO₂F)₂), LiCF₃SO₃, LiAsF₆, LiSbF₆, LiClO₄ or a mixture thereof.

Furthermore, the lithium salt may be an imide-based salt. For example, the imide-based lithium salt may include lithium bis(trifluoro methanesulfonyl)imide (LiTFSI, LiN(SO₂CF₃)₂) and lithium bis(fluorosulfonyl)imide (LiFSI, LiN(SO₂F)₂). The lithium salt can maintain or improve ionic conductivity by appropriately maintaining chemical reactivity with an ionic liquid.

The ionic liquid refers to a salt or a room temperature molten salt that has a melting point equal to or lower than a room temperature, is in a liquid state at room temperature and is composed of only ions.

The ionic liquid may be a compound including a) one or more cations selected from ammonium-based, pyrrolidinium-based, pyridinium-based, pyrimidinium-based, imidazolium-based, piperidinium-based, pyrazolium-based, oxazolium-based, pyridazinium-based, phosphonium-based, sulfonium-based, and triazolium-based cations and a mixture thereof, and b) one or more anions selected from BF₄—, PF₆—, AsF₆—, SbF₆—, AlCl₄—, HSO₄—, ClO₄—, CH₃SO₃—, CF₃CO₂—, Cl—, Br—, I—, BF₄—, SO₄—, CF₃SO₃—, FSO₂₂N—, (C₂F₅SO₂)₂N—, (C₂F₅SO₂, CF₃SO₂)N—, and (CF₃SO₂)₂N—.

The ionic liquid may be, for example, one or more selected from the group consisting of N-methyl-N-propylpyrrolidinium bis(trifluoromethanesulfonyl)imide, N-butyl-N-methylpyrrolidium bis(3-trifluoromethylsulfonyl)imide, 1-butyl-3-methylimidazolium bis(trifluoromethylsulfonyl)amide, and 1-ethyl-3-methylimidazolium bis(trifluoromethylsulfonyl)amide.

A weight ratio of the solid electrolyte and the ionic liquid in the solid electrolyte layer may be 0.1:99.9 to 90:10, for example, 10:90 to 90:10, 20:80 to 90:10, 30:70 to 90:10, 40:60 to 90:10, or 50:50 to 90:10. The solid electrolyte layer that satisfies the above range can maintain or improve ionic conductivity by improving an electrochemical contact area with the electrode. Accordingly, the energy density, discharge capacity, rate characteristics, and the like of the all-solid battery can be improved.

The all-solid battery may be a unit battery having a structure of a positive electrode/a solid electrolyte layer/a negative electrode, a bi-cell having a structure of a positive electrode/a solid electrolyte layer/a negative electrode/a solid electrolyte layer/a positive electrode, or a stacked battery in which the structure of the unit cell is repeated.

A shape of the all-solid battery is not particularly limited, and may be, for example, a coin type, a button type, a sheet type, a stack type, a cylindrical shape, a flat type, or the like. In addition, the all-solid battery may also be applied to large-sized batteries used in electric vehicles, and the like. For example, the all-solid battery may also be used in a hybrid vehicle such as a plug-in hybrid electric vehicle (PHEV). Furthermore, it can be used in fields that require a large amount of power storage, and for example, can also be used for an electric bicycle, an electric tool or the like.

The pressing process for an all-solid rechargeable battery is performed to achieve effects of increasing the capacity density of the active material for an electrode plate and increasing adhesion between the electrode current collector and the active material after a coating process for either a positive electrode plate or a negative electrode plate is completed.

A roll pressing process is a process of compressing an electrode plate to a desired thickness by passing it between two rolls. For compression to the desired thickness, the roll pressing process is carried out at high temperature and high pressure.

In addition, all-solid secondary batteries require a pressing process, in order to press a stacked unit cell of a positive electrode/a solid electrolyte/a negative electrode to thus densify the solid electrolyte and reduce an electrical resistance at an interface between the solid electrolyte and the electrode plate. To improve the productivity of the pressing process, an embodiment of the present invention exemplifies a roll press.

In the roll press, when roll pressing a unit cell including two or more positive and negative electrode plates, the electrode plate is introduced in a sheet state or introduced while being unwound from a reel on which it is wound without length restrictions. In this case, a difference in thickness is present between neighboring unit cells, and if the roll pressing is performed in a state where the difference in thickness is present, the electrode plate may be damaged.

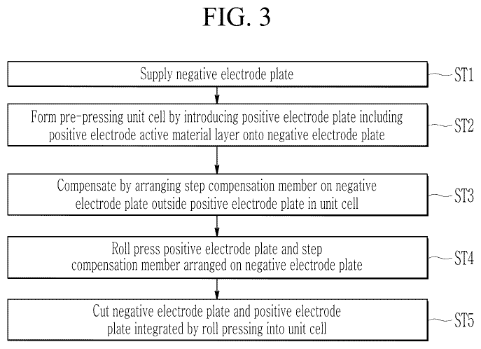

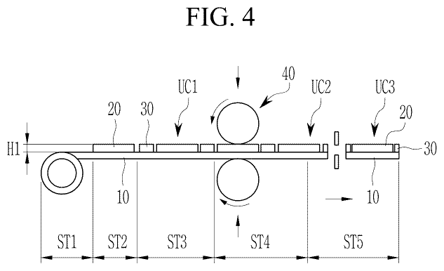

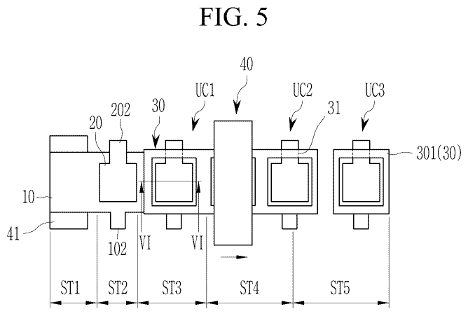

FIG. 3 is a flow chart of a method of manufacturing a unit cell of an all-solid rechargeable battery according to a first embodiment of the present invention, FIG. 4 is a side view showing the method of manufacturing a unit cell of an all-solid rechargeable battery according to the first embodiment of the present invention, and FIG. 5 is a plan view of FIG. 4.

Referring to FIGS. 3 and 4, the first embodiment provides a method of manufacturing a unit cell of an all-solid rechargeable battery for minimizing damage to an electrode plate due to a difference in thickness when roll pressing a pre-pressing unit cell.

The unit cell manufacturing method of the first embodiment includes a first step ST1, a second step ST2, a third step ST3, a fourth step ST4, and a fifth step ST5. The first step ST1 involves continuously supplying a negative electrode plate 10 while unwinding it from a reel 41 on which it is wound. Since the negative electrode plate 10 is continuously supplied, the roll pressing can be implemented continuously even without providing a separate conveying means.

The second step ST2 involves introducing and stacking a positive electrode plate 20 with a positive electrode active material layer onto the negative electrode plate 10 in a single sheet state. That is, the second step ST2 forms a pre-pressing unit cell UC1. Since the positive electrode plate 20 is introduced in a single sheet, accumulation of misalignment with the negative electrode plate 10 can be prevented.

The third step ST3 involves arranging a step compensation member 30 on the negative electrode plate 10 positioned outside the positive electrode plate 20 in the pre-pressing unit cell UC1. The step compensation member 30 compensates for a step set as a height from an inner surface of the negative electrode plate 10 to an outer surface of the positive electrode plate 20. That is, the step compensation member 30 removes the step formed between adjacent pre-pressure unit cells UC1, preventing damage to corner portions due to concentrated pressing loads on outer corners of the unit cells UC1 during roll pressing for the pre-pressing unit cells UC1.

The fourth step ST4 involves roll pressing the positive electrode plate 20 and the step compensation member 30 arranged on the negative electrode plate 10 by passing them between a pair of press rolls 40, resulting in a post-pressing unit cell UC2. The press rolls 40 press the unit cell UC1 and the step compensation member 30.

The negative electrode plate 10 can be unwound from the reel 41 on which it is wound and advanced while under tensile force from the pressing rotational drive of the press rolls 40. The fifth step ST5 involves cutting the negative electrode plate 10 and positive electrode plate 20 integrated by the roll pressing into the unit cell to complete a unit cell UC3. In this case, the step compensation member 30 is also cut together with the unit cell UC3.

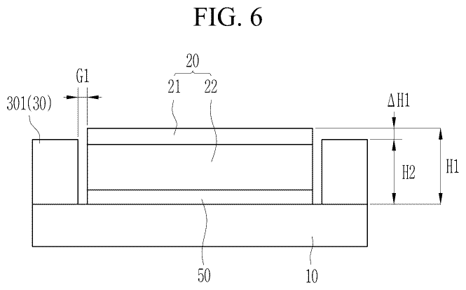

FIG. 6 is a cross-sectional view showing a height relationship between the unit cell of FIG. 4 and a step compensation member. Referring to FIG. 6, in the second step ST2, a positive electrode plate 20 including a positive electrode active material layer 22 on a positive electrode current collector 21 and a solid electrolyte layer 50 on the positive electrode active material layer 22 is introduced. That is, the positive electrode plate 20 is introduced onto the negative electrode plate 10.

Referring again to FIGS. 4 and 5, in the third step ST3, the step compensation member 30 is supplied in a continuous structure corresponding to a plurality of unit cells (UC1, UC2). For convenience, in the first embodiment, the step compensation member 30 is provided with a length corresponding to four unit cells (UC1, UC2).

In the second step ST2, the positive electrode plate 20 having a lead tab 202 on one side is supplied. The lead tab 202 of the positive electrode plate 20 is arranged on an opposite side to a lead tab 102 of the negative electrode plate 10 with respect to a direction orthogonal to an advancing direction. That is, the lead tabs 102 and 202 protrude in opposite directions in the unit cell UC3.

In the third step ST3, each unit compensation portion 301, corresponding to the unit cell UC1, of the step compensation member 30 is arranged outside the positive electrode plate 20 to compensate for the step. As an example, the step compensation member 30 may be formed in a quadrilateral frame structure corresponding to a periphery of the unit cell UC1 formed in a rectangular shape.

The quadrilateral frame structure facilitates handling of the step compensation member 30 by connecting each unit compensation portion 301 to each other while compensating for the step between the unit cells UC1. In the third step ST3, the step compensation member 30 of a corresponding quadrilateral frame structure is supplied.

Regarding this, the step compensation member 30 has an accommodation groove 31 corresponding to the lead tab 202 of the positive electrode plate 20 to accommodate the lead tab 202, thereby preventing an excessive increase in thickness in the area of the lead tab 202. As an example, the step compensation member 30 may be made of an adhesive tape of a synthetic resin film material or a paper tape.

In the third step ST3, a first gap G1 is formed between a periphery of the positive electrode plate 20 and an inner surface of the unit compensation portion 301 when viewed in an advancing direction (from left to right in FIG. 4) of the unit cells (UC1, UC2). As the unit compensation portion 301 gets closer to the positive electrode plate 20, the first gap G1 becomes smaller.

During the roll pressing, the unit compensation portion 301 being compressed effectively prevents damage to the positive electrode active material layer 22. However, as the first gap G1 becomes smaller, the unit compensation portion 301 being compressed becomes deformed, which may laterally displace the positive electrode active material layer 22 and disturb the alignment of the positive electrode plate 20 and the negative electrode plate 10.

Therefore, the first gap G1 is set such that, during the roll pressing, the unit compensation portion 301 is positioned as close as possible to the positive electrode active material layer 22 while being deformed without contacting it, thereby preventing damage to the positive electrode active material layer 22. Since a paper tape is less compressible than an adhesive tape, it can have a smaller thickness and allow for a smaller first gap G1 compared to the adhesive tape.

In the third step ST3, an upper surface of the positive electrode plate 20 is made to have a first height difference ΔH1 higher than an upper surface of the unit compensation portion 301 when viewed in a roll pressing direction (vertical direction in FIG. 4) for the unit cell (UC1, UC2). That is, the unit compensation portion 301 is formed lower than the positive electrode plate 20.

As an example, in the third step ST3, the step compensation member 30 having a thickness H2 corresponding to 80 to 90% of a total thickness H1 of the positive electrode plate 20 and the solid electrolyte layer 50 is supplied (H2=0.8 to 0.9H1). The step compensation member 30 includes the unit compensation portion 301. If the thickness H2 of the step compensation member 30 is less than 80% of the thickness H1, damage to the positive electrode active material layer 22 may begin. When the thickness H2 is 80 to 90% of the thickness H1, damage to the positive electrode active material layer 22 can be effectively prevented.

Referring again to FIGS. 4 to 6, in the fourth step ST4 of roll pressing the unit cell (UC1, UC2), the step compensation member 30, i.e., the unit compensation portion 301, is first pressed by the press rolls 40, then the positive electrode current collector 21 of the unit cell UC1 is pressed. After the pressing for the unit cell UC1 is completed, the step compensation member 30 is continuously pressed again. In this way, during the roll pressing for the unit cell UC1, the step compensation member 30 is first pressed in at the start by the press rolls 40 and then finally pressed out at the end, so that damage to the positive electrode active material layer 22 can be prevented despite the first height difference ΔH1. The quadrilateral frame structure of the step compensation member 30 can also effectively prevent damage to the positive electrode active material layer 22 in a longitudinal direction of the press rolls 40.

In the fifth step ST5, the step compensation member 30 is removed from the pressed unit cell UC3 to ultimately complete a unit cell (not shown). These unit cells can be stacked to assemble an all-solid rechargeable battery with a required capacity.

Hereinafter, various embodiments of the present invention will be described. Compared to the first embodiment and the previously described embodiment, descriptions of the same components will be omitted and descriptions of different components will be given.

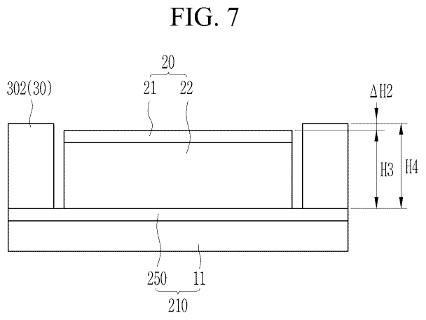

FIG. 7 is a cross-sectional view showing a height relationship between a unit cell and a step compensation member in a method of manufacturing a unit cell of an all-solid rechargeable battery according to a second embodiment of the present invention. Referring to FIG. 7, in a method of manufacturing a unit cell of an all-solid rechargeable battery according to the second embodiment, in the first step ST1, a negative electrode plate 210 including a solid electrolyte layer 250 on a negative electrode current collector 11 is introduced.

In the third step ST3, the upper surface of the positive electrode plate 20 is made to have a second height difference ΔH2 lower than an upper surface of a unit compensation portion 302 when viewed in the roll pressing direction (vertical direction in FIG. 4) for the unit cell (UC1, UC2). That is, the unit compensation portion 302 is formed lower than the positive electrode plate 20.

As an example, in the third step ST3, the step compensation member 30 having a thickness H4 corresponding to 80 to 110% of a total thickness H3 of the positive electrode current collector 21 and the positive electrode active material layer 22 is supplied (H4=0.8 to 1.1H3). The step compensation member 30 includes the unit compensation portion 301. If the thickness H4 of the step compensation member 30 is less than 80% of the thickness H3, damage to the positive electrode active material layer 22 may begin. If the thickness H4 of the step compensation member 30 exceeds 110% of the thickness H3, the step compensation member 30 is compressed and deformed, which may laterally displace the positive electrode active material layer 22 and disturb the alignment of the positive electrode plate 20 and the negative electrode plate 210. When the thickness H4 is 80 to 110% of the thickness H3, damage to the positive electrode active material layer 22 can be effectively prevented.

Referring again to FIGS. 4 to 7, in the fourth step ST4 of roll pressing the unit cell (UC1, UC2), the step compensation member 30, i.e., the unit compensation portion 302, is first pressed sufficiently by the press rolls 40, then the positive electrode current collector 21 of the unit cell UC1 is pressed. After the pressing for the unit cell UC1 is completed, the step compensation member 30 is sufficiently pressed again. In this way, during the roll pressing for the unit cell UC1, the step compensation member 30 is first sufficiently pressed in at the start by the press rolls 40 and then finally pressed out at the end, so that damage to the positive electrode active material layer 22 can be prevented despite the second height difference ΔH2. The quadrilateral frame structure of the step compensation member 30 can also effectively prevent damage to the positive electrode active material layer 22 in the longitudinal direction of the press rolls 40.

In the first embodiment, the step compensation member 30 having a thickness H2 corresponding to 80 to 90% of the thickness H1 can prevent damage to the positive electrode active material layer 22 while minimizing a decrease in pressing density of the positive electrode active material layer 22.

In contrast, in the second embodiment, the step compensation member 30 can mainly function to prevent damage to the positive electrode active material layer 22 with the thickness H4 corresponding to 90 to 110% of the thickness H3, thereby further preventing damage to the positive electrode active material layer 22. In addition, in the second embodiment, the step compensation member 30 can mainly function to increase the pressing density of the positive electrode active material layer 22 with the thickness H4 corresponding to 80 to 90% of the thickness H3, as in the first embodiment.

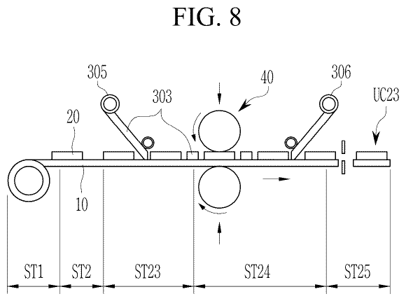

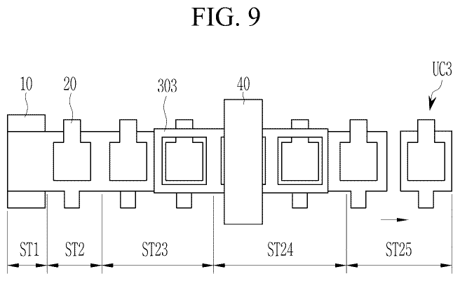

FIG. 8 is a side view of a method of manufacturing a unit cell of an all-solid rechargeable battery according to a third embodiment of the present invention, and FIG. 9 is a plan view of FIG. 8. Referring to FIGS. 8 and 9, in the method of manufacturing a unit cell of an all-solid rechargeable battery according to the third embodiment, the fourth step ST24 further includes a step of continuously removing a pressed step compensation member 303.

That is, in the fourth step ST24, after the roll pressing is performed, the step compensation member 303 is removed. To this end, in the third step ST23, an unwinding reel 305 supplies the step compensation member 303 on an entry side of the press rolls 40, and in the fourth step ST24, a rewinding reel 306 removes the step compensation member 303 on an exit side of the press rolls 40. Accordingly, the third embodiment can facilitate the supply and removal of the step compensation member 303 compared to the first embodiment.

In this case, the fifth step ST25 involves cutting the negative electrode plate 10 and positive electrode plate 20 integrated by the roll pressing to complete a unit cell UC23. In this case, the step compensation member 303 is not included in the cutting target, so the burden on the cutting unit is reduced.

What has been described above is only one embodiment for carrying out the all-solid rechargeable battery of the present disclosure, and the present disclosure is not limited to the above-described embodiments. The technical spirit of the present disclosure lies in that one skilled in the art to which the present disclosure belongs could make various changes, as claimed in the claims below, without departing from the gist of the present disclosure.

<Description of symbols>

| | |
|---|---|
| 10: negative electrode plate | 11: negative electrode current collector |
| 20: positive electrode plate | 21: positive electrode current collector |
| 22: positive electrode active | |
| material layer | |
| 30: step compensation member | |
| 31: accommodation groove | 40: press roll |
| 41: reel | 50: solid electrolyte layer |
| 102: 202: lead tab | 210: negative electrode plate |
| 250: solid electrolyte layer | 301: unit compensation portion |
| 303: step compensation member | G1: first gap |
| H1, H2, H3, H4: thickness | UC1, UC2, UC3, UC23: unit cell |
| ΔH1: first height difference | ΔH2: second height difference |

1. A method of manufacturing a unit cell of an all-solid rechargeable battery, the method comprising:
continuously supplying a negative electrode plate in a reel state;
forming a pre-pressing unit cell by introducing a positive electrode plate comprising a positive electrode active material layer in a single sheet state onto the negative electrode plate;
compensating for a step set as a height from an inner surface of the negative electrode plate to an outer surface of the positive electrode plate by arranging a step compensation member on the negative electrode plate outside the positive electrode plate in the unit cell;
roll pressing the positive electrode plate and the step compensation member arranged on the negative electrode plate by passing them between a pair of press rolls; and
cutting the negative electrode plate and positive electrode plate integrated by the roll pressing into the unit cell.

2. The method of claim 1, wherein:
in the forming, the positive electrode plate comprising a positive electrode active material layer on a positive electrode current collector and a solid electrolyte layer on the positive electrode active material layer is introduced.

3. The method of claim 1, wherein:
in the supplying, the negative electrode plate comprising a solid electrolyte layer on a negative electrode current collector is introduced.

4. The method of claim 1, wherein:
in the compensating, the step compensation member is supplied in a continuous structure corresponding to a plurality of the unit cells.

5. The method of claim 4, wherein:
in the forming, the positive electrode plate comprising a lead tab on one side is supplied, and
in the compensating, the step is compensated for by arranging a unit compensation portion, corresponding to the unit cell, of the step compensation member outside the positive electrode plate.

6. The method of claim 5, wherein:
in the compensating, a first gap G1 is formed between a periphery of the positive electrode plate and an inner surface of the unit compensation portion when viewed in an advancing direction of the unit cell.

7. The method of claim 6, wherein:
in the compensating, an upper surface of the positive electrode plate is made to have a first height difference ΔH1 higher than an upper surface of the unit compensation portion when viewed in a roll pressing direction for the unit cell.

8. The method of claim 7, wherein:
in the compensating, the step compensation member having a thickness corresponding to 80 to 90% of a total thickness of the positive electrode plate and a solid electrolyte layer is supplied.

9. The method of claim 6, wherein:
in the compensating, an upper surface of the positive electrode plate is made to have a second height difference ΔH2 lower than an upper surface of the unit compensation portion when viewed in a roll pressing direction for the unit cell.

10. The method of claim 9, wherein:
in the compensating, the step compensation member having a thickness corresponding to 80 to 110% of a total thickness of a current collector and a positive electrode active material layer of the positive electrode plate is supplied.

11. The method of claim 4, wherein:
in the compensating, the step compensation member is formed in a quadrilateral frame structure corresponding to a periphery of the unit cell formed in a rectangular shape and supplied.

12. The method of claim 1, wherein:
in the compensating, an adhesive tape or a paper tape is supplied as the step compensation member.

13. The method of claim 1, wherein:
the roll-pressing further comprises continuously removing the step compensation member that has been pressed.
